(19) United States
(12) Patent Application Publication
(10) Pub. No.: US 2004/0037505 A1
(43) Pub. Date: Feb. 26, 2004

(54) Fiber Bragg Grating interferometers for chromatic dispersion compensation

(75) Inventor: Michel Morin, Sillery (CA)

Correspondence Address: DARBY & DARBY P.C., P. O. BOX 5257, NEW YORK, NY, 10150-5257, US

(73) Assignee: Teraxion Inc., Sainte-Foy (CA)

(21) Appl. No.: 10/601,065

(22) Filed: Jun. 20, 2003

(30) Foreign Application Priority Data
Jun. 21, 2002 (CA) 2,391,179

(51) Int. Cl. G02B 6/34

(52) U.S. Cl. 385/37

(57) ABSTRACT

All fiber construction Gires-Tournois interferometers for chromatic dispersion compensation of an optical signal are provided. The interferometers are made of overlapping chirped fiber Bragg gratings having a wide band reflectivity response. In one embodiment, a plurality of FBG interferometers can be cascaded for providing the chromatic dispersion compensation. In another embodiment, an FBG dispersion compensator provided with a pair of multi-cavity FBG interferometers is also provided. The dispersion compensator is provided with two temperature controlling means, each being operationally connected to one of the multi-cavity interferometer for thermo-optically shifting a spectral response thereof, thereby providing a tunable dispersion compensator capable of compensating for all orders of dispersion.

### FIELD OF THE INVENTION

The present invention relates to optical communication systems and more particularly concerns the compensation of chromatic dispersion in such systems.

### BACKGROUND OF THE INVENTION

The present invention addresses the compensation of chromatic dispersion in optical communication systems. Chromatic dispersion designates the spectral dependence of the group velocity of light propagating along an optical fiber link [1,2]. It produces a distortion and lengthening of light pulses propagating along an optical fiber, which can eventually result in the overlap of neighboring pulses. This limits the distance over which an optical signal can be transmitted and maintained in a detectable form without reshaping. It is especially troublesome in high bit rate systems, since the distortion of the optical signal resulting from chromatic dispersion scales as the square of the signal bandwidth. Chromatic dispersion is a major limiting factor in 10 and 40 Gb/s systems.

Various chromatic dispersion compensation techniques have been devised and are reviewed in Chapter 9 of [2]. Dispersion compensation is still a field of active research, aimed at improving performances and tunability and reducing costs [3-16]. A notable advance has been the achievement of multi-channel dispersion over up to thirty-two channels using superposed fiber Bragg gratings [16,17]. This approach allows adjusting individually the dispersion level over each channel, rendering possible the compensation of the dispersion slope as well. Gires-Tournois interferometers are also suitable as multi-channel dispersion compensators, since their spectral response is naturally periodic with regards to the optical frequency. The Gires-Tournois interferometer is a Fabry-Perot interferometer with a totally reflective back mirror that was devised from the start as a dispersion compensator [18]. Except for intra-cavity losses, the Gires-Tournois interferometer totally reflects light at all wavelengths. However, it modulates the phase of the reflected light periodically with the optical frequency. As a result, the group delay is modulated periodically as well, photons at resonant (anti-resonant) optical frequencies making the most (least) round trips inside the cavity. The same group delay curve, and hence dispersion, can be applied over the spectral bandwidth of each channel when the spectral period of the interferometer, known as the free spectral range (FSR), equals the channel frequency spacing.

The Gires-Tournois interferometer was first used to compress laser pulses or compensate for the dispersion inside ultra-short pulse lasers [19-23]. Numerical simulations showed that dispersion compensation with such an interferometer could double the transmission distance of 8 Gb/s signals over an optical fiber link [24,25]. These simulations were followed by experiments that led to improvements in the transmission of optical signals at rates of 5 and 8 Gb/s [26,27]. Following this, Dilwali and Soundra Pandian evaluated theoretically the optical fiber ring resonator for dispersion compensation [28]. This resonator behaves similarly as the Gires-Tournois interferometer but operates in transmission rather than in reflection. Finally, Ouellette et al. compared the Gires-Tournois interferometer to the chirped fiber Bragg grating for dispersion compensation [29]. Their analysis underlined the limited capacity of the interferometer to provide a sizable and constant dispersion over a large signal bandwidth.

The dispersion that can be achieved over a given bandwidth can be increased by cascading interferometers or by using multi-cavity interferometers [30-33]. This observation renewed the interest in the Gires-Tournois interferometer for dispersion compensation. A cascade of interferometers or a multi-cavity interferometer preserves the spectral periodic behavior of each individual cavity as long as all cavities have the same FSR. They thus remain suitable for a multi-channel operation, while providing a level of dispersion that scales roughly as the number of cavities involved [31,33]. Design parameters that can be adjusted to obtain a desired dispersion response are the number of cavities, the reflectivity of the mirrors (other than the totally reflective back mirrors), and the optical phase angle associated with a round trip inside each cavity. The design of a cascade of single-cavity interferometers is rather straightforward, the overall dispersion then being simply the sum of the dispersion of each individual interferometer [34]. The design of a multi-cavity interferometer is more involved because all cavities must be considered as a whole. It can rely on digital filter design techniques [30,31,35,36].

Dispersion compensation by a cascade of interferometers has been demonstrated using ring cavities [3,32-34,37-39] and micro-electromechanical (MEMS) Gires-Tournois interferometers [3,34,40,41]. Ring cavities present important limitations. Increasing the FSR requires a concomitant decrease in the ring radius. For example, a 50 GHz FSR requires a ring radius smaller than 1 mm. Small ring radii can result in intra-cavity optical losses [38]. The birefringence of small radius rings also produces a strong polarization mode dispersion (PMD), that must be avoided by using light polarized along a principal axis of the rings.

Dispersion compensation by multi-cavity interferometers has been demonstrated experimentally as well. Jablonski et al. have developed thin-film-based two-cavity Gires-Tournois interferometers to compensate for the dispersion slope in very high bit rate optical time-domain multiplexing (OTDM) systems [42-48]. The thinness of their cavities translated into very large FSRs (many THz). Bulk multi-cavity interferometers made of a stack of thin-film-coated silica substrates have also been used for dispersion compensation [4,5]. The substrate thickness was adjusted to produce FSRs that matched system channel spacings (50, 100 and 200 GHz).

A highly desirable feature for a dispersion compensator is tunability. The dispersion of a cascade of interferometers can be adjusted by varying the front mirror reflectivity of each interferometer as well as the optical phase angle associated with a roundtrip inside each of said interferometer. Both parameters could be adjusted within the MEMS interferometers used by Madsen et al. [40,41]. Each interferometer comprised a silicon substrate supporting a thin membrane whose position was controlled with an electrical voltage. The combination of this membrane and the top surface of the silicon substrate acted, through a Fabry-Perot effect, as a mirror with a reflectivity that could be adjusted electrically from 0 to 70%. The interferometer was completed by a highly reflective coating deposited on the bottom surface of the silicon substrate. The thickness of the substrate translated into a FSR of 100 GHz. The optical phase angle of the cavity was adjusted thermo-optically with a thermoelectric element controlling the temperature of the substrate. With a cascade of two such interferometers, the dispersion over a useful bandwidth of 50 GHz could be adjusted from −102 to +109 ps/nm. Two approaches have been used to adjust the dispersion of a cascade of ring cavities. In both cases, the optical phase around each cavity was adjusted thermally. Horst et al. used couplers that could be adjusted thermally as well [38]. Madsen et al. replaced each coupler by a Mach-Zehnder interferometer [3,34,37,39]. The coupling to each cavity was then varied by changing the temperature of one arm of the interferometer associated to it. The dispersion of a cascade of four such ring cavities could be varied from −1980 to +1960 ps/nm over a passband of 13.8 GHz corresponding to 60% of the FSR (23 GHz) of the device.

Jablonski et al. have used a variety of methods to adjust the dispersion of their multi-cavity device. Dispersion tunability was afforded, for example, by a variable thickness air gap [43,47] or by profiled thin film layers [44,45]. Dispersion was also varied by changing the number of reflections undergone by an optical signal zigzagging between two dispersion compensators [46,48].

The principle of operation of the dispersion compensator presented by Moss et al. ensures tunability [4,5]. Their compensator comprises two multi-cavity interferometers, each interferometer providing a dispersion that varies linearly over a given bandwidth. The dispersion slopes of the interferometers are equal in magnitude but of opposite signs. The dispersion resulting from cascading the two interferometers is proportional to the spectral shift between them, which is controlled thermally. This approach also applies when dispersion slopes are in a simple ratio. For example, a type A interferometer can be cascaded with two type B interferometers given that the dispersion slope of the latter is twice as small in magnitude.

A Gires-Tournois interferometer has a periodic spectral response and thus provides the same dispersion over all channels separated in frequency by the FSR of said interferometer. The interferometer does not provide compensation for the dispersion slope per se. Slope compensation has been built into the dispersion response of an interferometer as follows. Madsen et al. replaced the coupler to a ring cavity by an asymmetric Mach-Zehnder interferometer with arms of different lengths [37]. The asymmetric interferometer provides a coupling that varies slowly with wavelength. As a result, the ring cavity produces a dispersion that varies slowly from channel to channel. A similar behavior has been obtained by Moss et al. through the use of a vernier effect [4,5]. As aforementioned, the dispersion in their compensator results from a spectral shift between two interferometers with linearly varying dispersions of opposite slopes. To obtain dispersion slope compensation, two interferometers with slightly different FSRs are used. The slight mismatch in FSRs produces a gradual shift between successive periods of the spectral response of the first interferometer with regards to corresponding periods of the second interferometer. This gradual shift translates into a dispersion level changing from channel to channel.

A number of patents are related to the compensation of dispersion with Gires-Tournois interferometers. Some are concerned with the tunable compensation of dispersion within ultra-short pulse lasers [49-51]. Patents [52-54] disclose thin film structures that can be regarded as multi-cavity interferometers, developed also for laser applications. These inventions do not provide dispersion levels compatible with telecommunications applications. Patent [55] addresses the compensation of dispersion in an optical communication link with a Gires-Tournois interferometer. The cavity length of the interferometer could be adjusted to optimize the dispersion compensation. Patent [56] discloses an adjustable Gires-Tournois dispersion compensator in which light transmitted by the highly reflective back mirror is used to monitor the state of the compensation. Patent [57] discloses the use of a cascade of interferometers or of multi-cavity interferometers for the compensation of dispersion. Configurations operating in transmission (ring cavities) and reflection (Gires-Tournois interferometers) are both disclosed. Patent [58] discloses a dispersion compensator based on a Gires-Tournois interferometer, either single or multi-cavity, into which light is launched at an angle. The light can thus be made to enter and exit the device at separate points. The launch angle can also be adjusted to fine tune the FSR of the interferometer. A Gires-Tournois dispersion compensator operated with an oblique incidence of light is also disclosed in patent [59]. The optical path length of the cavity can be adjusted either with a tilted glass plate or a piezo-electric element. This patent also discloses the use of a cascade of such interferometers to increase the achievable dispersion levels. Patent [60], emanating from the same original application as patent [58], also discloses a Gires-Tournois dispersion compensator. Jablonski et al. have deposited two patent applications disclosing their dispersion compensator [61,62]. A variety of geometries are presented to achieve multiple reflections on two thin-film based multi-cavity Gires-Tournois interferometers facing one another. The tunable dispersion compensator presented in [4,5] has been disclosed also in patent application [63]. The invention disclosed therein includes polarization optics to shift laterally an optical beam, in order to achieve multiple reflections at a normal incidence on each multi-cavity Gires-Tournois bulk interferometers and hence increase the achievable dispersion levels.

A fiber Bragg grating consists in a quasi-periodic modulation of the index of refraction along the core of an optical fiber [64,65]. It is created by exposing a photosensitive fiber to a properly shaped intensity pattern of ultraviolet light. This light produces a permanent change in the index of refraction in selected sections of the optical fiber. The resulting optical fiber grating behaves as a wavelength-selective reflector having a characteristic reflectance spectral response. The wavelength of light that is reflected by the grating is called the Bragg wavelength. More or less complex spectral responses can be obtained by properly tailoring the refractive index modulation along the optical fiber. Their stability and reliability, in conjunction with their all-guided-wave nature, have made fiber Bragg gratings ideal candidates for fiber optic system applications. They are now used extensively in the field of optical telecommunications, e.g. for wavelength division multiplexing (WDM), for compensating chromatic dispersion in optical fibers, for stabilizing and flattening the gain of optical amplifiers and for stabilizing the frequency of semiconductor lasers.

The first fiber Bragg grating Fabry-Perot interferometer was realized in 1992 [66]. It was made of two narrow band (0.3 nm) gratings with a constant period. The gratings were separated by 10 cm, leading to a 1 GHz FSR. Following this, wide band (150 nm) interferometers were demonstrated using chirped fiber Bragg gratings [67]. A low finesse interferometer with a FSR approaching 200 GHz was demonstrated with partially overlapping gratings. More recently, an interferometer with a FSR of 100 GHz and a finesse of up to 16 was obtained similarly with overlapping chirped fiber Bragg gratings [68].

The realization of a wide band fiber interferometer with a FSR on the order of 50-200 GHz requires some overlapping of the chirped gratings found therein, because said gratings are longer than the required cavity length (0.5-2 mm). The successful operation of these interferometers relies on the fact that interference between overlapping Bragg gratings occurs only between those points at which said gratings have the same local Bragg wavelength. This fact was demonstrated in references [16,17], where up to 16 gratings with different Bragg wavelengths were superposed in a dispersion compensator, each grating compensating for the dispersion over a single channel as expected. Dispersion compensation with fiber Bragg grating interferometers has not been reported yet. Moreover, it has not been generally recognized that wide band interferometers with FSRs of interest (50-200 GHz) could be produced using overlapping Bragg gratings. For example, it is stated in patent application [69] that: “Cavities are formed in the optical fiber between fiber Bragg grating reflectors. However a multi-cavity filter in fiber has a limited free spectral range (FSR) insufficient for a telecommunications system. For a typical 100 GHz FSR required in the telecommunications industry, the cavity length is about 1 mm. A Bragg grating reflector, if manufactured using commonly available grating-writing techniques, would need to be longer than 1 mm, and hence the two reflector cavity structure would be too long to achieve the necessary FSR.”

### SUMMARY OF THE INVENTION

The present invention relies on the use of Gires-Tournois interferometers for chromatic dispersion compensation. The interferometers are designed to produce a chromatic dispersion opposite that of an optical fiber link carrying an optical signal. More specifically, the disclosed interferometers are made of fiber Bragg gratings. In the present instance, the fiber Bragg gratings act as the reflectors of all-fiber Gires-Tournois interferometers.

In accordance with one aspect of the present invention, the interferometers are made of chirped gratings with a wide band reflectivity response. Overlapping gratings allows producing cavities short enough to obtain FSRs (50-200 GHz) that match the channel spacing of optical communications systems.

In one embodiment of the invention, there is provided a Fiber Bragg Grating interferometer embedded in an optical fiber for a chromatic dispersion compensation of an optical signal. The FBG interferometer is provided with a first and a second overlapping gratings, each having an identical predetermined chirp rate and a wide band reflectivity response. The first grating has a first refractive index modulation for providing a substantially total reflectivity of said first grating. The second grating has a second refractive index modulation being lower than said first one for providing a partial reflectivity of said second grating. Said gratings are longitudinally shifted from one another by a predetermined distance L, thereby defining a Fiber Bragg Grating Gires-Tournois interferometer cavity therebetween for providing the chromatic dispersion compensation of the optical signal.

In a further embodiment, the Fiber Bragg Grating interferometer is provided with a third overlapping grating having a wide band reflectivity response and the same predetermined chirp rate than said first and second gratings. The third grating is longitudinally shifted by the same predetermined distance L relatively to the second grating for defining a second cavity between said second and third gratings, thereby providing a multi-cavity FBG Gires-Tournois interferometer. The Fiber Bragg Grating interferometer may advantageously be further provided with a plurality of additional shifted overlapping gratings defining a plurality of additional cavities longitudinally distributed with the first and second cavities along the optical fiber.

In another embodiment of the present invention, there is provided an optical system for a chromatic dispersion compensation of an optical signal comprising a plurality of FBG interferometers. Each of the FBG interferometers is provided with a first and a second overlapping gratings, each having an identical predetermined chirp rate and a wide band reflectivity response. The first grating has a first refractive index modulation for providing a substantially total reflectivity of said first grating. The second grating has a second refractive index modulation being lower than said first one for providing a partial reflectivity of said second grating. Said gratings are longitudinally shifted from one another by a predetermined distance L, thereby defining a Fiber Bragg Grating Gires-Tournois interferometer cavity therebetween. The optical system is also provided with coupling means for cascading the plurality of FBG interferometers. The coupling means has an input port for receiving the optical signal and an output port for outputting said optical signal after successive reflections through each of the plurality of FBG interferometers, thereby providing the chromatic dispersion compensation of the optical signal.

In another embodiment of the present invention, there is also provided a Fiber Bragg Grating based dispersion compensator. The FBG based dispersion compensator is provided with a multi-cavity Fiber Bragg Grating interferometer. The multi-cavity FBG interferometer comprises a first, a second and a third overlapping gratings. Each of the gratings has an identical predetermined chirp rate and a wide band reflectivity response. The first grating has a first refractive index modulation for providing a substantially total reflectivity of said first grating. Each of the second and third gratings respectively has a second and a third refractive index modulation being lower than said first one for providing a partial reflectivity of each of said gratings. The second grating is longitudinally shifted in a defined direction by a predetermined distance L relatively to the first grating for defining a first cavity between said first and second gratings. The third grating is longitudinally shifted in the same defined direction by the same distance L relatively to the second grating for defining a second cavity between said second and third gratings, thereby providing a multi-cavity FBG Gires-Tournois interferometer. The FBG based dispersion compensator is also provided with coupling means operationally connected to the multi-cavity FBG interferometer. The coupling means has an input port for receiving an optical signal and an output port for outputting said optical signal after a reflection thereof through the multi-cavity FBG interferometer, thereby providing a chromatic dispersion compensation of said optical signal.

In a further embodiment, the FBG based dispersion compensator is also provided with a second multi-cavity FBG interferometer operationally connected to the coupling means. The dispersion compensator is also provided with two temperature controlling means, each being operationally connected to one of the FBG interferometers for thermo-optically shifting a spectral response thereof, thereby providing a tunable dispersion compensation.

The all fiber construction of the interferometers described therein ensures compactness and an increased stability and robustness in comparison to bulk interferometers.

### BRIEF DESCRIPTION OF THE DRAWINGS

These and other objects and advantages of the invention will become apparent upon reading the detailed description thereof and upon referring to the drawings in which:

FIG. 1 is a schematic representation of a single-cavity fiber Bragg grating Gires-Tournois interferometer according to a preferred embodiment of the present invention.

FIG. 2 is a schematic representation of a multi-cavity fiber Bragg grating Gires-Tournois interferometer according to another preferred embodiment of the present invention.

FIG. 3 is a graph of the spectral variation of the group delay of a single-cavity Gires-Tournois interferometer.

FIG. 4 is a graph of the linear group delay of an ideal dispersion compensator.

FIG. 5 is a schematic representation of a cascade of two single-cavity Gires-Tournois interferometers according to another preferred embodiment of the present invention.

FIG. 6 is a schematic representation of a dispersion compensator with a multi-cavity Gires-Tournois interferometer according to another preferred embodiment of the present invention.

FIG. 7 is a schematic representation of a tunable dispersion compensator with multi-cavity Gires-Tournois interferometers according to another preferred embodiment of the present invention.

FIG. 8 illustrates the principle of operation of a tunable dispersion compensator based on a pair of multi-cavity Gires-Tournois interferometers (PRIOR ART).

FIG. 9 illustrates the principle of operation of a tunable dispersion compensator with a dispersion adjustment range centered around a non-zero dispersion according to another preferred embodiment of the present invention.

FIG. 10 illustrates a dispersion slope compensation with a vernier effect (PRIOR ART).

While the invention will be described in conjunction with an example embodiment, it will be understood that it is not intended to limit the scope of the invention to such embodiment. On the contrary, it is intended to cover all alternatives, modifications and equivalents as may be included as defined by the appended claims.

### DESCRIPTION OF PREFERRED EMBODIMENTS OF THE INVENTION

In the following description, similar features in the drawings have been given similar reference numerals and in order to simplify the figures, some elements are not referred to in some figures if they were already identified in a preceding figure.

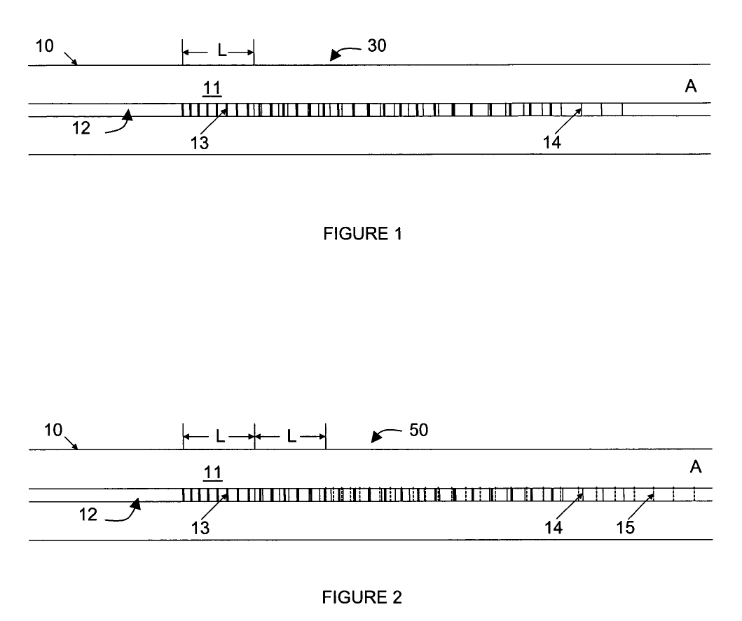

The present invention concerns all-fiber Gires-Tournois interferometers for dispersion compensation. With reference to FIG. 1, the present invention provides a Fiber Bragg Grating interferometer 30 embedded in an optical fiber 10 for a chromatic dispersion compensation of an optical signal. The FBG interferometer comprises a first and a second overlapping gratings 13, 14 written in the core 12 of the optical fiber 10. The two gratings 13, 14 can also extend inside the cladding 11 of the optical fiber 10 to avoid cladding mode losses. (The lateral extent of the index modulations 13 and 14 is limited by the lateral extent of the photosensitivity area of the optical fiber 10.) Each of the gratings 13, 14 has an identical predetermined chirp rate, as illustrated by the varying period of the index modulations. Each of the gratings 13, 14 also has a wide band reflectivity response, which can be identical or not. The first grating 13 has a first refractive index modulation, illustrated by thick lines, for providing a substantially total reflectivity of said first grating 13. It is to be understood that such first refractive index modulation is strong enough to produce a reflectivity of the grating approaching 100%. Thus, throughout the present description, the expression “substantially total reflectivity” is intended to cover a reflectivity approaching 100%. The second grating 14 has a second refractive index modulation, illustrated by thin lines, being lower than said first one for providing a partial reflectivity of said second grating 14. Said gratings 13, 14 are longitudinally shifted from one another by a predetermined distance L along the fiber core 12, thereby defining a Fiber Bragg Grating Gires-Tournois interferometer cavity therebetween for providing the chromatic dispersion compensation of the optical signal. The distance L determines the Gires-Tournois cavity length. The FSR of the FBG interferometer 30 is determined by the distance L and the group velocity of the fundamental mode of the optical fiber 10. Typically, a cavity length L of about 1 mm will lead to a FSR of about 100 GHz. Current and contemplated communication systems require a FSR ranging from 12.5 to 200 GHz, corresponding to a cavity length ranging from about 0.5 to 8 mm. Light propagating in the fiber core 12 from side A is essentially totally reflected by the gratings 13, 14, but undergoes a group delay that varies periodically with the optical frequency.

The FBG interferometer can also be provided with more gratings in order to provide a multi-cavity FBG Gires-Tournois interferometer. Thus, referring now to FIG. 2, there is shown a FBG interferometer 50 as previously described and being further provided with a third overlapping grating 15 having a wide band reflectivity response and the same predetermined chirp rate than the first and second gratings 13, 14. The third grating 15 is longitudinally shifted by the same predetermined distance L relatively to the second grating 14 for defining a second cavity between the second and third gratings 14, 15, thereby providing a multi-cavity FBG Gires-Tournois interferometer. Thus, the length of the cavity defined by gratings 14 and 15 is the same as the length of the cavity defined by gratings 13 and 14. This ensures that the multi-cavity interferometer 50 still has a periodical spectral response with the same FSR as determined by distance L. The index modulation of grating 15, illustrated by dotted lines, produces a partial reflectivity. As with the single-cavity interferometer, light propagating in the fiber core from side A is totally reflected by the gratings, but undergoes a group delay that varies periodically with the optical frequency. The periodical variation of the group delay is however different from that obtained with the single-cavity interferometer. It depends on the reflectivity of each grating and on the optical phase associated with a round trip inside each of the cavities defined by gratings 13 and 14 and gratings 14 and 15. The illustrated interferometer has three reflectors 13, 14, 15 and two cavities and thus represents the simplest form of a multi-cavity interferometer. It is understood that more gratings can be added in order to increase the number of cavities inside the interferometer. Thus, in another preferred embodiment which is not illustrated, the FBG interferometer is further provided with a plurality of additional shifted overlapping gratings defining a plurality of additional cavities longitudinally distributed with the first and second cavities along the optical fiber 10.

These fiber Bragg grating interferometers can be used in a variety of ways to achieve dispersion compensation, as exemplified in embodiments described below. Gratings can be written with appropriately polarized UV beams in order to minimize birefringence effects [68]. Fiber Bragg grating interferometers thus avoid detrimental birefringence effects associated with small ring cavities, the latter being usable only with polarized light. The possibility of writing many overlapping gratings provides more flexibility for the design and fabrication of multi-cavity interferometers with desired dispersion properties. Their all fiber construction also ensures compactness and an increased stability and robustness in comparison to bulk interferometers.

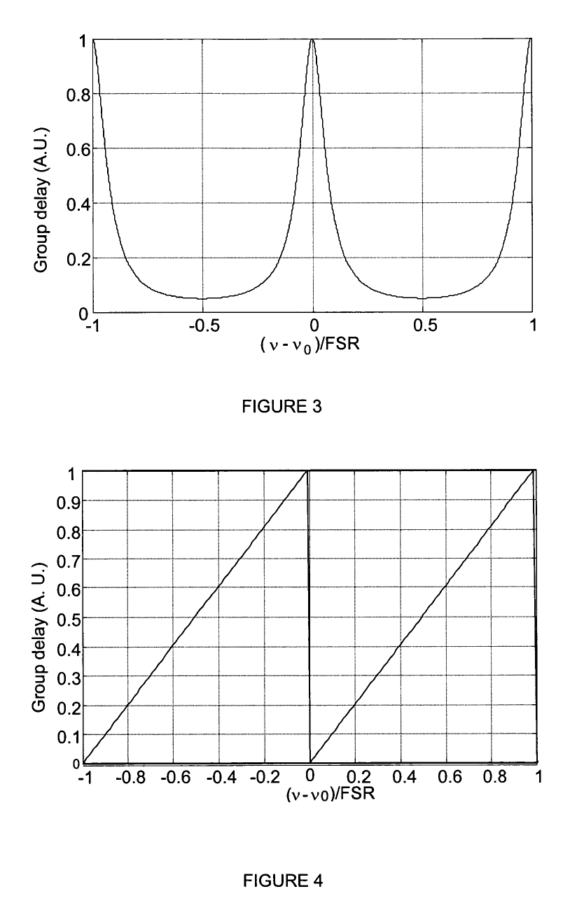

Referring now to FIG. 3, there is shown the periodical variation of the group delay with respect to the optical frequency of a single-cavity Gires-Tournois interferometer. As can be seen, the variation of the group delay over a spectral period is highly nonlinear. This limits drastically the dispersion levels that are achievable with a single-cavity Gires-Tournois interferometer over a given bandwidth. An ideal dispersion compensator would rather produce a linear group delay as illustrated in FIG. 4.

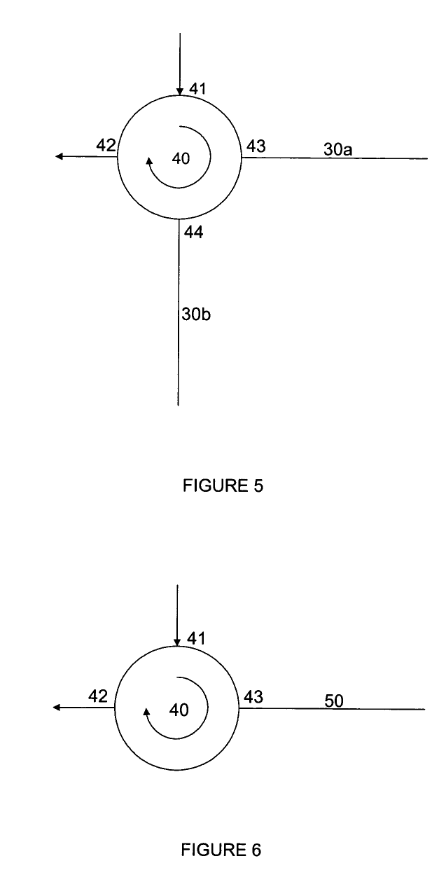

A linear group delay response can be approximated by cascading single-cavity Gires-Tournois interferometers, as shown for example in reference [34]. A practical implementation of this approach with fiber Bragg grating interferometers is illustrated in FIG. 5. More particularly, the illustrated embodiment is provided with two single cavity Gires-Tournois interferometers 30a and 30b as described above. Of course, it is to be understood that a plurality of interferometers could also be cascaded. The illustrated optical system is also provided with coupling means for cascading the FBG interferometers 30a and 30b. The coupling means has an input port 41 for receiving the optical signal and an output port 42 for outputting the optical signal after successive reflections through each of the FBG interferometers 30a, 30b, thereby providing the chromatic dispersion compensation of the optical signal. The coupling means is preferably a circulator 40 having a plurality of intermediate ports 43, 44. Each of the intermediate ports 43, 44 receives one of the FBG interferometers 30a, 30b. The coupling means may also be a series of couplers or any other convenient means. In FIG. 5, a four-port circulator 40 having an input port 41, an output port 42 and two intermediate ports 43 and 44 is used. Two single-cavity Gires-Tournois interferometers 30a and 30b with the same FSR are located in the intermediate ports 43 and 44. Light enters the circulator 40 by input port 41, is then successively reflected by interferometers 30a and 30b and exits the circulator 40 by the output port 42. It is understood that using an N-port circulator instead allows cascading N-2 interferometers. Preferably, the temperature of each interferometer is controlled with appropriate means. Thus, each of the interferometers 30a and 30b is advantageously provided with a temperature controlling means operationally connected thereto in order to thermo-optically shift the spectral response of each interferometer 30a, 30b. Preferably, the temperature controlling means are thermoelectric cooler but any other appropriate means could also be envisaged. The mostly linear group delay response is obtained by properly positioning the spectral responses of the interferometers with regards to one another.

One advantage of chirped Bragg gratings is the easiness in controlling their reflectivity. By varying the strength of the index modulation along the fiber, it is very simple to produce such gratings with a reflectivity that depends on wavelength in a predetermined fashion. A cascade of interferometers made of fiber Bragg gratings with spectrally dependent reflectivities can be fabricated. Such a cascade will produce a dispersion that varies from channel to channel, thus allowing the compensation of the dispersion slope as well.

The dispersion achievable over a given bandwidth can also be increased by using a multi-cavity Gires-Tournois interferometer 50 and a coupling means connected thereto, as illustrated in FIG. 6. Preferably, the coupling means is a three-port circulator 40. Light enters the circulator 40 via input port 41, is then reflected by multi-cavity Gires-Tournois interferometer 50 located in intermediate port 43 and then leaves the circulator via output port 42. Means other than a circulator, such as a coupler for example, can be used to extract the light reflected by the interferometer 50. Advantageously, the temperature of the multi-cavity interferometer 50 is controlled by temperature controlling means, such as a thermoelectric cooler, in order to align the periods of its spectral response with transmission channels. The multi-cavity interferometer is designed to produce a group delay response approximating the linear response illustrated in FIG. 4. The design parameters to this end are the number of cavities, equal to the number of gratings other than the highly reflective one, the reflectivity of the gratings other than the highly reflective one, and the relative optical phase associated with a roundtrip inside the cavities defined by neighboring gratings. The possibility of writing many overlapping gratings, demonstrated for example in reference [16,17], provides more flexibility in approximating a linear group delay over a sizable fraction of each period of the spectral response of the interferometer. During fabrication, two physical parameters can be used to control the relative optical phase of the cavities, i.e. the distance between the gratings and the average refractive index distribution along the fiber. The distance between the gratings can be controlled by writing them successively and changing between each the relative position of the optical fiber and the phase mask used to write said gratings with a sub-wavelength accuracy motion stage. The gratings can also be written simultaneously using a complex phase mask that predefines their relative positions. Once the gratings have been written, UV-exposure can be used to slightly modify the index of refraction of the fiber, a technique known as UV-trimming. Changing the refractive index of the optical fiber changes the optical phase of light propagating through it. UV-trimming is a well established technique in the field of fiber Bragg gratings. This technique of course applies only to materials that are photosensitive, such as the optical fibers used to fabricate FBGs.

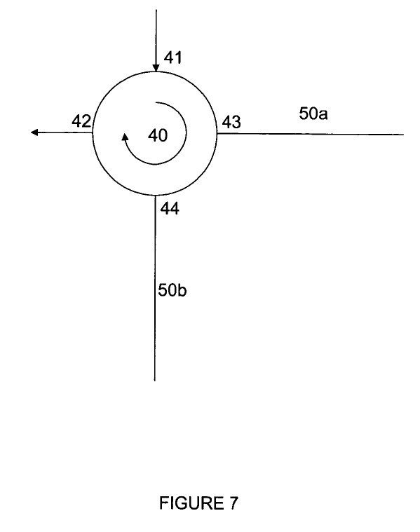

A tunable dispersion compensator can be fabricated using a pair of multi-cavity interferometers as disclosed in patent application [63]. A fiber Bragg grating implementation of this approach is illustrated in FIG. 7. The set-up is the same as for a cascade of two single-cavity interferometers illustrated in FIG. 5, except that the single-cavity interferometers 30a and 30b have been replaced by multi-cavity interferometers 50a and 50b. Multi-cavity interferometers 50a and 50b have the same FSR. They produce over each period of their spectral response a dispersion that varies linearly, their dispersion slopes being equal in absolute value but of opposite signs. The temperature of both interferometers 50a and 50b is controlled by appropriate means, such as thermoelectric coolers, as a non-limitative example, in order to vary the spectral shift between the two.

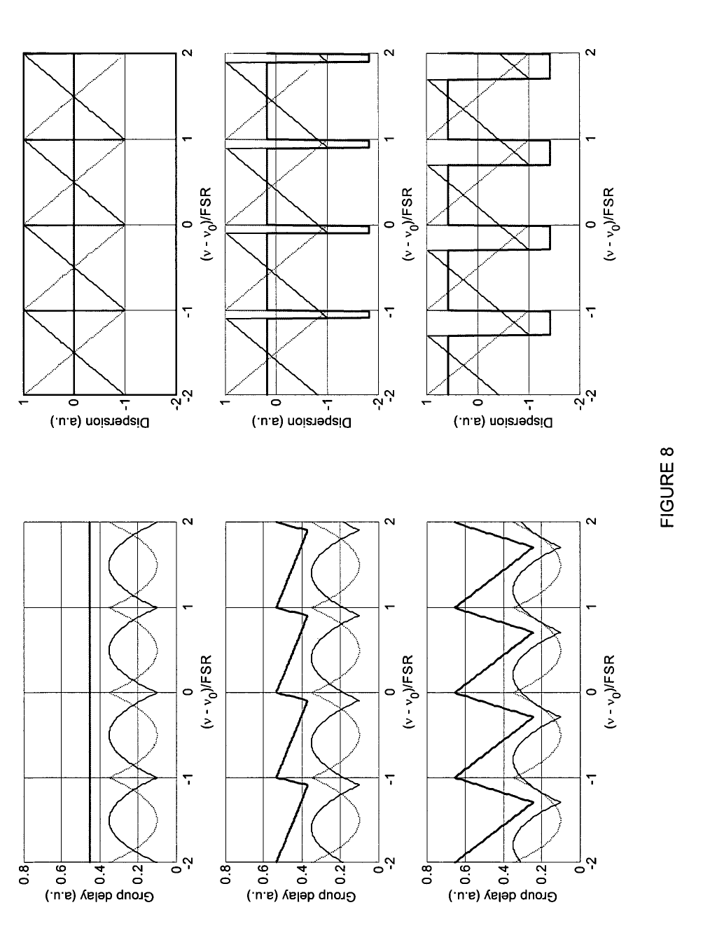

The principle of operation of such a dispersion compensator is illustrated in FIG. 8. Graphs on the left represent the group delay of the interferometers while those on the right represent their dispersions. These graphs are representative of an ideal case where the group delay of each interferometer is parabolic over the whole period of the spectral response. Thin curves apply to individual interferometers 50a and 50b, whereas thick curves represent the sum of their group delays and dispersions available at output port 42. In the top graphs, the spectral responses of the interferometers 50a and 50b are perfectly aligned. The sum of their group delays is then constant and a zero dispersion results. As the spectral shift between the interferometers increases, so does the slope of the resulting group delay and hence the dispersion. Inverting the spectral shift produces a negative dispersion rather than a positive one as shown in FIG. 8. This figure also shows that an increase in dispersion comes along with a concomitant decrease in the useful bandwidth over which the desired dispersion is obtained. (The zones of negative dispersion in FIG. 8 are undesirable artifacts resulting form the superposition of neighboring periods of the spectral responses of the interferometers.)

The group delay variation over a spectral period of a single-cavity Gires-Tournois interferometer is not parabolic, as shown in FIG. 3. The possibility of superposing many fiber Bragg gratings gives more flexibility in achieving the required positive and negative parabolic group delay variations illustrated in FIG. 8 over a sizable fraction of the spectral period of each interferometer.

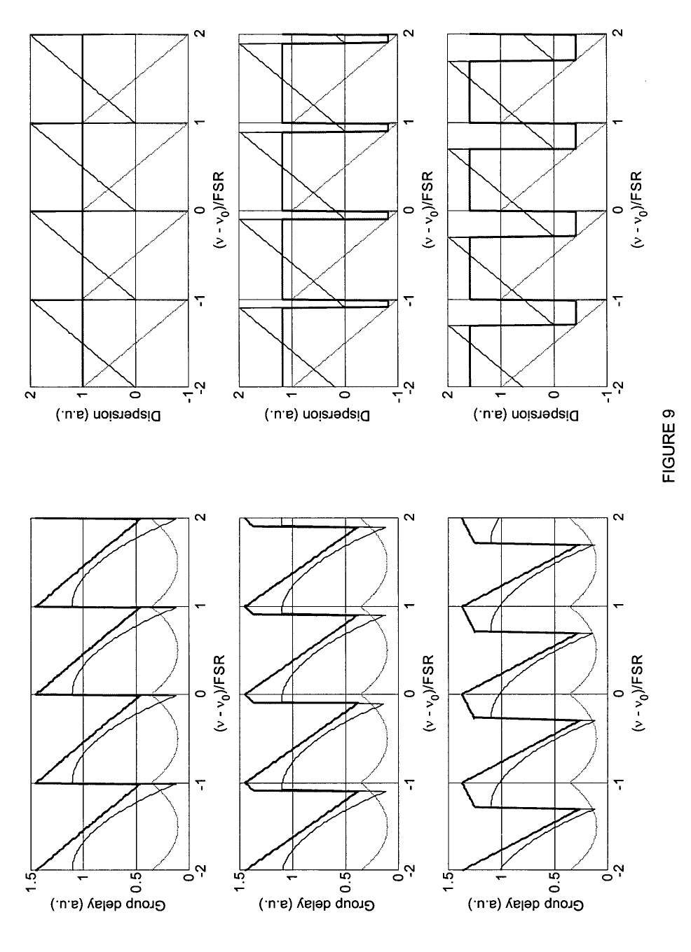

A bulk multi-cavity interferometer is more easily manufactured when the optical path length of each cavity is the same. The fabrication can then proceed as follows. A substrate of a suitable optical material is first polished to a thickness providing the desired FSR. It is then cut into pieces that are thin-film coated and assembled to form the multi-cavity interferometer. The equality in optical thickness for all cavities results in the group delay curve of the multi-cavity interferometer being symmetric over each period of the spectral response. This is the case for the multi-cavity interferometer disclosed in patent application [63]. This symmetry has an unfortunate consequence: a pair of interferometers with symmetric group delay curves produces a dispersion adjustment range that is centered around a zero dispersion level, as illustrated in FIG. 8. All results obtained with this type of dispersion compensator that have been published to this day are consistent with this observation [4,5]. In order to center the dispersion adjustment range around a non-zero dispersion, it is necessary to introduce some asymmetry in the spectral response of one interferometer. This case is illustrated in FIG. 9, where the group delay represented by thin solid curves in the left graphs is clearly not symmetric over a period of the spectral response. As seen in the top graphs, the dispersion takes a non-vanishing value when the spectral responses of the interferometers are perfectly aligned. A thermally-induced spectral shift between the interferometers results in a variation of the dispersion around this non-vanishing value. A bulk multi-cavity interferometer with an asymmetric group delay curve, and thus with a different optical phase from cavity to cavity, will be much more difficult to fabricate. Fiber Bragg grating fabrication techniques are better suited for this task.

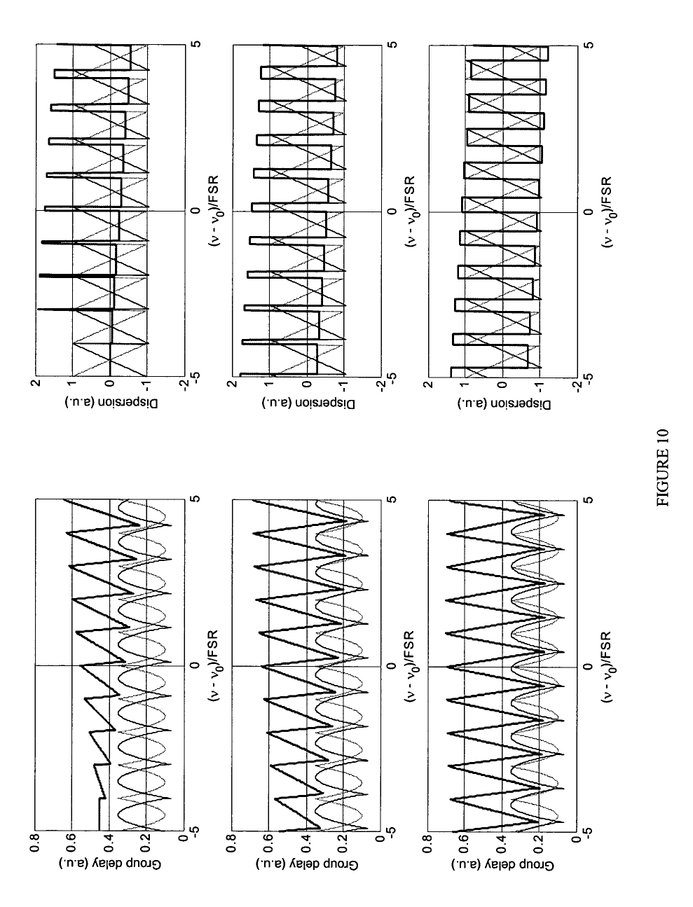

The vernier effect has been used to implement some dispersion slope compensation with a pair of multi-cavity interferometers of slightly different FSRs [4,5]. This approach is illustrated in FIG. 10, where the group delay curves have slightly different periodicities. The first periods to the left of the graphs are perfectly aligned, so that dispersion over this channel vanishes. The increasing shift between the periods resulting from the difference in FSRs produces a dispersion that increases from channel to channel when moving to the right of the graphs. Shifting further the spectral response of one interferometer with regards to the other, by thermal means for example, adds the same dispersion to all channels without modifying the dispersion slope created by the difference in FSR, as illustrated in the middle and lower graphs in FIG. 10. This approach has two disadvantages. Firstly, the dispersion slope is not proportional to the absolute dispersion level but remains constant as determined by the difference in FSRs of the two interferometers. This behavior does not match the evolution of the dispersion affecting an optical signal propagating along an optical fiber. The dispersion in each channel increases proportionally to the distance of propagation in the fiber, albeit at a possibly different rate from channel to channel. Under such conditions, it is clear that the difference in dispersion between two channels will be proportional to the dispersion level in each. Secondly, dispersion slope compensation through a vernier effect uses up some of the dispersion adjustment range afforded by the multi-cavity interferometers, as seen in FIG. 10. This is so because the dispersion slope compensation and the thermally induced dispersion both result from a relative shift between periods of the spectral response of the interferometers, the allowed total shift being limited by the minimum fractional bandwidth of each channel over which the dispersion compensation is required.

The vernier approach can be implemented with fiber Bragg grating interferometers. However, fiber Bragg gratings offer a much better approach towards dispersion slope compensation. One can use a pair of multi-cavity interferometers made of fiber Bragg gratings, each grating (other than those with a high reflectivity) having a reflectivity that varies with the optical frequency. The spectral variation of the reflectivity of the gratings is designed in such a way that each interferometer still produces a dispersion that varies linearly over a sizable fraction of each period of its spectral response. However, the slope of the linearly varying dispersion of each interferometer varies from channel to channel. The dispersion of the pair of interferometers will thus vary linearly with the thermally induced spectral shift between them, as previously, but at a rate that will vary from channel to channel. This method will provide a dispersion slope compensation that is proportional to the dispersion levels in each channel. A properly designed pair of interferometers will actually be capable of compensating for all orders of dispersion. Moreover, the useful fractional bandwidth over which the dispersion compensation is achieved will be the same for all channels.

In conclusion, Fiber Bragg grating Gires-Tournois interferometers can be used for dispersion compensation. These interferometers avoid the birefringence limitations of ring cavities. They are compact and will likely be more robust than their bulk counterparts. Fiber Bragg grating fabrication techniques will make it easier to control the relative optical phases of cavities in multi-cavity interferometers. The spectral variation of the reflectivity of fiber Bragg gratings can also be controlled easily. This will allow the design and fabrication of devices capable of compensating for all orders of dispersion.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention.

### CITED REFERENCES

[1] G. P. Agrawal, Nonlinear fiber optics, Second Edition (Academic Press, San Diego, 1995).

[2] G. P. Agrawal, Fiber-Optic Communication Systems, Second Edition (John Wiley & Sons, Inc., New York, 1997).

[3] C. K. Madsen, “Integrated waveguide allpass filters tunable dispersion compensators,” OFC 2002, paper TuT1.

[4] D. J. Moss, et al., “Multichannel tunable dispersion compensation using an allpass multi-cavity etalons,” OFC 2002, paper TuT2.

[5] D. J. Moss, et al., “Multichannel tunable dispersion compensation using all-pass multi-cavity etalons,” Proc. SPIE TD01, 476-478 (2002).

[6] M. Tur, U. Levy, and Y. Danzinger, “Modules for chromatic dispersion and dispersion slope management,” OFC 2002, paper TuT4.

[7] M. Wandel, et al., “Dispersion compensating fibers for non-zero dispersion fibers,” OFC 2002, paper WU1.

[8] S. Matsuo, et al., “New medium-dispersion fiber with large effective area and low dispersion slope,” OFC 2002, paper WU2.

[9] S. N. Knudsen, “Design and manufacture of dispersion compensating fibers and their performance in systems,” OFC 2002, paper WU3

[10] A. Walter and G. Schaefer, “Chromatic dispersion variations in ultra-long-haul transmission systems arising from seasonal soil temperature variations,” OFC 2002, paper WU4.

[11] S. Ramachandran, “Higher-order-mode dispersion compensation for broadband dispersion and non-linearity management in transmission systems,” OFC 2002, paper WU5.

[12] J. E. Rothenberg, et al., “High-channel-count fiber Bragg gratings fabricated by phase-only sampling,” OFC 2002, paper ThAA1.

[13] T. Sugihara, et al., “Automatically tracked dispersion compensation with penalty-free tunable dispersion equalizer for 40 Gbit/s systems,” OFC 2002, paper ThAA2.

[14] G. E. Kohnke, et al., “Fiber Bragg gratings for dispersion compensation,” OFC 2002, paper ThAA3.

[15] Y. W. Song, et al., “Tunable dispersion slope compensation for WDM systems using a single non-channelized third-order-chirped FBG,” OFC 2002, paper ThAA4.

[16] Y. Painchaud, et al., “Multi-channel fiber Bragg gratings for dispersion and slope compensation,” OFC 2002, paper ThAA5.

[17] R. L. Lachance, et al, “Fiber Bragg gratings and chromatic dispersion,” Proc. SPIE 4833, 1009-1016 (2002).

[18] F. Gires and P. Tournois, “Interféromètre utilisable pour Ia compression d'impulsions lumineuses modulées en fréquence,” Comptes Rendus de l'Académie des Sciences de Paris 258, 6112-6115 (1964).

[19] J. A. Giordmaine, et al, “Compression of optical pulses,” IEEE Journal of Quantum Electronics QE-4, 252-255 (1968).

[20] M. A. Duguay and J. W. Hansen, “Compression of pulses from a mode-locked He-Ne laser,” Applied Physics Letters 14, 14-16 (1969).

[21] J. Heppner and J. Kuhl, “Intracavity chirp compensation in a colliding pulse mode-locked laser using thin-film interferometers,” Applied Physics Letters 47, 453-455 (1985).

[22] J. Kuhl and J. Heppner, “Compression of femtosecond optical pulses with dielectric multilayer interferometers,” IEEE Transactions on Quantum Electronics QE-22, 182-185 (1986).

[23] K. D. Li, et al, “Broadband cubic-phase compensation with resonant Gires-Tournois interferometers,” Optics Letters 14, 450-452 (1989).

[24] L. J. Cimini, et al, “Optical equalization for high-bit-rate fiber-optic communications,” IEEE Photonics Technology Letters 2, 200-202 (1990).

[25] L. J. Cimini, et al, “Optical equalization to combat the effects of laser chirp and fiber dispersion,” Journal of Lightwave Technology 8, 649-659 (1990).

[26] A. Gnauck, et al., “Optical equalization of fiber chromatic dispersion in a 5-Gb/s transmission system,” IEEE Photonics Technology Letters 2, 585-587 (1990).

[27] A. H. Gnauck, et al., “8-Gb/s-130 km transmission experiment using Er-doped fiber preamplifier and optical dispersion equalization,” IEEE Transactions Photonics Technology Letters 3, 1147-1149 (1991).

[28] S. Dilwali and G. Soundra Pandian, “Pulse response of a fiber dispersion equalizing scheme based on an optical resonator,” IEEE Photonics Technology Letters 4, 942-944 (1992).

[29] F. Ouellette, et al, “All-fiber devices for chromatic dispersion compensation based on chirped distributed resonant coupling,” Journal of Lightwave Technology 12, 1728-1738 (1994).

[30] C. K. Madsen and G. Lenz, “Optical all-pass filters for phase response design with applications for dispersion compensation,” IEEE Photonics Technology Letters 10, 994-996 (1998).

[31] G. Lenz and C. K. Madsen, “General optical all-pass filter structures for dispersion control in WDM systems,” Journal of Lightwave Technology 17, 1248-1254 (1999).

[32] C. K. Madsen, et al., “An all-pass filter dispersion compensator using planar waveguide ring resonators,” OFC/IOOC 1999, paper FE-6.

[33] C. K. Madsen, et al., “Multistage dispersion compensator using ring resonators,” Optics Letters 24, 1555-1557 (1999).

[34] C. K. Madsen, “Tunable dispersion compensators based on optical allpass filters,” in IEEE LEOS Newsletter (2001), pp. 20-21.

[35] E. M. Dowling and D. L. MacFarlane, “Lightwave lattice filters for optically multiplexed communication systems,” Journal of Lightwave Technology 12, 471-486 (1994).

[36] K. Jinguji, “Synthesis of coherent two-port optical delay-line circuit with ring waveguides,” Journal of Lightwave Technology 14, 1882-1898 (1996).

[37] C. K. Madsen, et al., “Integrated all-pass filters for tunable dispersion and dispersion slope compensation,” IEEE Photonics Technology Letters 11, 1623-1635 (1999).

[38] F. Horst, et al., “Tunable ring resonator dispersion compensators realized in high-refractive-index contrast SiON technology,” ECOC 2000, post-deadline papers.

[39] C. K. Madsen, et al., “Compact integrated tunable chromatic dispersion compensator with a 4000 ps/nm tuning range,” OFC 2001, paper PD9.

[40] C. K. Madsen, et al., “A tunable dispersion compensating MARS all-pass filter,” ECOC'99, Vol.II, 20-21 (1999).

[41] C. K. Madsen, et al., “A tunable dispersion compensating MEMS all-pass filter,” IEEE Photonics Technology Letters 12, 651-653 (2000).

[42] M. Jablonski, et al, “Design of allpass filters for third order dispersion compensation,” ECOC'99, Vol I, 316-317 (1999).

[43] M. Jablonski, et al., “Adjustable coupled two-cavity allpass filter for dispersion slope compensation of optical fibres,” Electronics Letters 36, 511-512 (2000).

[44] M. Jablonski, et al., “Layered optical thin-film allpass dispersion equalizer (LOTADE): a novel device compensating for dispersion slope of optical fibers,” CLEO'2000, paper CPD16.

[45] M. Jablonski, et al., “Layered optical thin-film allpass dispersion equaliser for compensation of dispersion slope of optical fibers,” Electronics Letters 36, 1139-1141 (2000).

[46] M. Jablonski, et al., “Adjustable dispersion-slope compensator using entirely thin-film coupled-cavity allpass filters in a multi-reflection parallel configuration,” OFC 2001, paper TuS3.

[47] M. Jablonski, et al, “The realization of all-pass filters for third-order dispersion compensation in ultrafast optical fiber transmission systems,” Journal of Lightwave Technology 19, 1194-1205 (2001).

[48] M. Jablonski, et al., “Entirely thin-film allpass coupled-cavity filters in a parallel configuration for adjustable dispersion-slope compensation,” IEEE Photonics Technology Letters 13, 1188-1190 (2001).

[49] D. K. Negus and T. Johnston, U.S. Pat. No. 5,173,908.

[50] J. D. Kafka, et al., U.S. Pat. No. 5,185,750.

[51] J. D. Kafka, et al, U.S. Pat. No. 5,212,698.

[52] R. R. Austin and B. Golubovic, U.S. Pat. No. 6,081,379

[53] R. R. Austin and R. I. Edmond, U.S. Pat. No. 6,154,318.

[54] R. R. Austin and R. I. Edmond, U.S. Pat. No. 6,222,673.

[55] L. J. Cimini, et al, U.S. Pat. No. 5,023,947.

[56] J. Ip, U.S. Pat. No. 5,557,468.

[57] R. F. Kazarinov, et al., U.S. Pat. No. 6,289,151.

[58] P. Colbourne, et al, European patent application EP1098211.

[59] S. Wu and S. X. F. Cao, U.S. Pat. No. 6,487,342.

[60] P. Colbourne, et al, U.S. Pat. No. 6,519,065.

[61] M. K. Jablonski, et al., US patent application 2002/0044738 A1.

[62] M. K. Jablonski, et al., US patent application 2002/0060865 A1.

[63] P. Colbourne, et al., US patent application 2001/0021053 A1.

[64] R. Kashyap, Fiber Bragg Gratings (Academic Press, San Diego, 1999).

[65] A. Othonos and K. Kalli, Fiber Bragg Gratings. Fundamentals and Applications in Telecommunications and Sensing. (Artech House, Boston, 1999).

[66] W. W. Morey, et al., “Fiber Fabry-Perot interferometer using side exposed fiber Bragg gratings,” OFC'92, paper WA2.

[67] G. E. Town, et al., “Wide-band Fabry-Perot-like filters in optical fiber,” IEEE Photonics Technology Letters 7, 78-80 (1995).

[68] S. Doucet, et al, “High-finesse large band Fabry-Perot fibre filter with superimposed chirped Bragg gratings,” Electronics Letters 38, 402-403 (2002).

What is claimed is:

1. A Fiber Bragg Grating interferometer embedded in an optical fiber for a chromatic dispersion compensation of an optical signal, said FBG interferometer comprising:
a first and a second overlapping gratings, each having an identical predetermined chirp rate and a wide band reflectivity response, the first grating having a first refractive index modulation for providing a substantially total reflectivity of said first grating, the second grating having a second refractive index modulation being lower than said first one for providing a partial reflectivity of said second grating, said gratings being longitudinally shifted from one another by a predetermined distance L, thereby defining a Fiber Bragg Grating Gires-Tournois interferometer cavity therebetween for providing the chromatic dispersion compensation of the optical signal.

2. The Fiber Bragg Grating interferometer according to claim 1, wherein each of said refractive index modulations extends inside a cladding of said optical fiber.

3. The Fiber Bragg Grating interferometer according to claim 1, further comprising a third overlapping grating having a wide band reflectivity response and the same predetermined chirp rate than said first and second gratings, said third grating being longitudinally shifted by the same predetermined distance L relatively to the second grating for defining a second cavity between said second and third gratings, thereby providing a multi-cavity FBG Gires-Tournois interferometer.

4. The Fiber Bragg Grating interferometer according to claim 3, further comprising a plurality of additional shifted overlapping gratings defining a plurality of additional cavities longitudinally distributed with said first and second cavities along said optical fiber.

5. The Fiber Bragg Grating interferometer according to claim 1, wherein said gratings are written simultaneously in the optical fiber with a complex phase mask predefining a relative position of each of said gratings.

6. The Fiber Bragg Grating interferometer according to claim 1, wherein each of said gratings are written with polarized UV beams.

7. The Fiber Bragg Grating interferometer according to claim 1, wherein said optical fiber embedding the FBG interferometer is UV exposed for modifying a refractive index of said optical fiber.

8. The Fiber Bragg Grating interferometer according to claim 1, wherein the reflectivity of said second grating depends on an optical frequency of said optical signal.

9. An optical system for a chromatic dispersion compensation of an optical signal comprising:
a plurality of FBG interferometers, each comprising:
a first and a second overlapping gratings, each having an identical predetermined chirp rate and a wide band reflectivity response, the first grating having a first refractive index modulation for providing a substantially total reflectivity of said first grating, the second grating having a second refractive index modulation being lower than said first one for providing a partial reflectivity of said second grating, said gratings being longitudinally shifted from one another by a predetermined distance L, thereby defining a Fiber Bragg Grating Gires-Tournois interferometer cavity therebetween; and
coupling means for cascading said plurality of FBG interferometers, said coupling means having an input port for receiving the optical signal and an output port for outputting said optical signal after successive reflections through each of said plurality of FBG interferometers, thereby providing the chromatic dispersion compensation of the optical signal.

10. The optical system according to claim 9, wherein said coupling means comprises a circulator having a plurality of intermediate ports, each of said intermediate ports receiving one of said plurality of FBG interferometers.

11. The optical system according to claim 9, wherein said coupling means comprises a series of couplers.

12. The optical system according to claim 9, further comprising a plurality of temperature controlling means, each being operationally connected to one of said plurality of FBG interferometers for thermo-optically shifting a spectral response thereof.

13. The optical system according to claim 12, wherein each of said plurality of temperature controlling means comprises a thermoelectric cooler.

14. A Fiber Bragg Grating based dispersion compensator comprising:
a multi-cavity Fiber Bragg Grating interferometer comprising:
a first, a second and a third overlapping gratings, each having an identical predetermined chirp rate and a wide band reflectivity response, the first grating having a first refractive index modulation for providing a substantially total reflectivity of said first grating, each of said second and third gratings respectively having a second and a third refractive index modulation being lower than said first one for providing a partial reflectivity of each of said gratings, the second grating being longitudinally shifted in a defined direction by a predetermined distance L relatively to the first grating for defining a first cavity between said first and second gratings, the third grating being longitudinally shifted in the same defined direction by the same distance L relatively to the second grating for defining a second cavity between said second and third gratings, thereby providing a multi-cavity FBG Gires-Tournois interferometer; and
coupling means operationally connected to said multi-cavity FBG interferometer, said coupling means having an input port for receiving an optical signal and an output port for outputting said optical signal after a reflection thereof through said multi-cavity FBG interferometer, thereby providing a chromatic dispersion compensation of said optical signal.

15. The Fiber Bragg Grating based dispersion compensator according to claim 14, wherein said coupling means comprises a circulator having an intermediate port for receiving said multi-cavity FBG interferometer.

16. The Fiber Bragg Grating based dispersion compensator according to claim 14, wherein said coupling means comprises a coupler.

17. The Fiber Bragg Grating based dispersion compensator according to claim 14, further comprising a temperature controlling means operationally connected to said multi-cavity FBG interferometer for thermo-optically shifting a spectral response thereof.

18. The Fiber Bragg Grating based dispersion compensator according to claim 17, wherein said temperature controlling means comprises a thermo electric cooler.

19. The Fiber Bragg Grating based dispersion compensator according to claim 14, wherein said multi-cavity FBG interferometer comprises a plurality of additional shifted overlapping gratings defining a plurality of additional cavities.

20. The Fiber Bragg Grating based dispersion compensator according to claim 14, wherein the respective reflectivity of each of said second and third gratings depends on an optical frequency of said optical signal.

21. The Fiber Bragg Grating based dispersion compensator according to claim 14, further comprising a second multi-cavity FBG interferometer operationally connected to said coupling means, said optical signal being outputted after successive reflections through each of said multi-cavity FBG interferometers.

22. The Fiber Bragg Grating based dispersion compensator according to claim 21, wherein said coupling means comprises a circulator having two intermediate ports, each receiving one of said multi-cavity FBG interferometers.

23. The Fiber Bragg Grating based dispersion compensator according to claim 21, wherein said coupling means comprises a series of couplers.

24. The Fiber Bragg Grating based dispersion compensator according to claim 21, wherein the respective reflectivity of each of said second and third gratings of each of said multi-cavity FBG interferometer depends on an optical frequency of said optical signal.

25. The Fiber Bragg Grating based dispersion compensator according to claim 21, further comprising a first and a second temperature controlling means, each being operationally connected to one of said multi-cavity FBG interferometers for thermo-optically shifting a spectral response thereof.

26. The Fiber Bragg Grating based dispersion compensator according to claim 25, wherein each of said temperature controlling means comprises a thermoelectric cooler.

27. The Fiber Bragg Grating based dispersion compensator according to claim 19, further comprising a second multi-cavity FBG interferometer operationally connected to said coupling means, said optical signal being outputted after successive reflections through each of said multi-cavity FBG interferometers.

28. The Fiber Bragg Grating based dispersion compensator according to claim 25, wherein each of said first and second temperature controlling means respectively applies a first and a second temperatures to each of said interferometers for providing a tunable dispersion compensation.
